(19) United States
(12) Patent Application Publication
(10) Pub. No.: US 2025/0172228 A1
(43) Pub. Date: May 29, 2025

(54) A SYSTEM FOR ENHANCING THE DAMPING CAPACITY AND ASEISMIC CAPACITY OF THE UNDERGROUND INTEGRATED PIPE RACK

(71) Applicants: Xiuling CAO, Shijiazhuang (CN); Muci YUE, Shijiazhuang (CN); HEBEI GEO UNIVERSITY, Shijiazhuang, Hebei (CN)

(72) Inventors: Xiuling CAO, Shijiazhuang (CN); Muci YUE, Shijiazhuang (CN); Qiangqiang SUN, Shijiazhuang (CN); Haiyan XU, Shijiazhuang (CN); Fawu WANG, Shijiazhuang (CN); Zhiqiang ZHAI, Shijiazhuang (CN); Anguelov K A., Shijiazhuang (CN); CASAGLI N., Shijiazhuang (CN); Zihan FENG, Shijiazhuang (CN); Shuo HAN, Shijiazhuang (CN); Xinzhi LIU, Shijiazhuang (CN)

(73) Assignees: Xiuling CAO, Shijiazhuang, HE (CN); Muci YUE, Shijiazhuang, HE (CN); HEBEI GEO UNIVERSITY, Shijiazhuang, Hebei (CN)

(21) Appl. No.: 18/715,750

(22) PCT Filed: Jul. 1, 2022
(86) PCT No.: PCT/CN2022/103390

§ 371 Date: Jun. 3, 2024

(30) Foreign Application Priority Data
Dec. 3, 2021 (CN) 202111465944.2

(51) Int. Cl. F16L 55/04; B66F 3/44

(52) U.S. Cl. CPC F16L 55/041; B66F 3/44

(57) ABSTRACT

The invention discloses a system for enhancing the damping and aseismic capacities of an underground integrated pipe rack. It includes a pipe fixing assembly installed on the inner walls of the underground space on both sides. The assembly comprises multiple lifting frames arranged vertically and a lifting mechanism. The telescopic end of the lifting mechanism is fixedly connected to the lowermost lifting frame. One side of the lifting frame is slidingly connected to the inner wall of the underground space and features a recess for placing the pipe. A pipe holder inside the recess secures the pipe. During vibrations, the lifting frame slides on the inner wall, causing relative movement between adjacent pipe holders. The vibration is absorbed by the telescopic spring, preventing hard contact between the pipe and the vibration source. This reduces vibration and protects the pipe, thereby enhancing the aseismic capacity of the underground pipe rack.

### TECHNICAL FIELD

The invention relates to the field of underground pipe rack technology, in particular to a system for enhancing the damping capacity and aseismic capacity of the underground integrated pipe rack.

### BACKGROUND ART

Integrated pipe rack refers to a integrated underground urban pipe corridor, that is, a tunnel space is constructed under the city, in which space utilities pipelines for electricity, communications, gas, heating, water supply and drainage and others are integrated into one, with special access hole, lifting hole and monitoring system arranged, and unified planning, unified design, unified construction and management implemented, and it is an important infrastructure and “lifeline” to ensure the operation of the city.

At present, the city's pipe rack is erected in a tunnel due to more pipelines, with the pipe rack taking the shape of the tunnel as a whole and built into the soil layer. Many channels are set in the pipe rack for pipeline erection. In the actual earthquake disaster, overall vibration displacement of the pipe rack tunnel as a whole will be generated in the earthquake longitudinal and transverse waves. The difference of expansion and contraction ratio of soil layers easily lead to cracking and even collapse of the tunnel, in which case, the channels mounted in the pipe rack tunnel will directly fall off and be damaged, resulting in damage to the pipeline.

In view of the above status quo, a system for enhancing the damping capacity and aseismic capacity of the underground integrated pipe rack is therefore urgently needed to overcome the shortcomings in the current practical application.

### SUMMARY

The purpose of the invention is to provide a system for enhancing the damping capacity and aseismic capacity of the underground integrated pipe rack to solve the problems raised in the above-mentioned background art.

In order to achieve the above purpose, the technical scheme adopted by the invention is as follows:

The invention relates to a system for enhancing the damping capacity and aseismic capacity of the underground integrated pipe rack, which includes a pipe fixing assembly installed at the inner wall of the underground space on both the left and right sides. The said pipe fixing assembly includes a number of lifting frames set vertically from top to bottom and a lifting mechanism. The telescopic end of the said lifting mechanism is fixedly connected to the lowermost lifting frame. One side of the said lifting frame is slidingly connected to the inner wall of the underground space. The lifting frame is provided with a recess for placing the pipe, and a pipe holder for fixing the pipe is installed inside the recess. A spherical slide block is movably mounted on the lower part of the pipe holder. The upper part of the pipe holder is also provided with an arc sliding chute for spherical slide block sliding. The spherical slide block is slidingly mounted in the arc sliding chute on the pipe holder on the adjacent side, and the spherical slide block is fixedly connected with the arc sliding chute through a telescopic spring.

As a further scheme of the invention, several sliding chutes are arranged on the inner wall on both the left and right sides in the said underground space, with the sliding chutes corresponding to the lifting frames one by one. The lifting frames are slidingly mounted on the sliding chutes through lifting slide blocks whose upper and lower ends are fixedly connected with the sliding chutes through the buffer spring.

As a further scheme of the invention, a mounting stem is vertically installed on the bottom of the said pipe holder, and the said spherical slide block is movably installed on the lower end of the mounting stem through universal joint. A through slot for mounting stem (5) installation is provided on the bottom of the pipe holder.

As a further scheme of the invention, the said pipe holder includes upper clamp and lower clamp, both of which are of semi-circular structure, with one end of upper clamp and lower clamp hinged to each other, and the other end of upper clamp and lower clamp detachably connected by fixing bolts.

As a further scheme of the invention, there are several pipe holders uniformly arranged along the pipe length direction, with the two adjacent pipe holders fixedly connected through several connecting rods.

As a further scheme of the invention, the said lifting mechanism includes a base, a sleeve and a lifting column; the said sleeve is fixedly installed in the said base, and the upper end of the sleeve is opened, in which the said lifting column is set; inside the said sleeve, there are two adjusting screws symmetrically connected in a threaded way on the left and right sides of the said lifting column, and screw sleeves are connected in a threaded way on the adjusting screws, with one side of the screw sleeve slidingly connected to the inner wall of the sleeve and the other side fixedly connected to the lifting column.

As a further scheme of the invention, synchronous pulleys are fixedly mounted on the lower end of the said adjusting screw, with two adjacent synchronous pulleys connected by a synchronous belt through transmission.

As a further scheme of the invention, a drive motor is fixedly mounted on the said sleeve, with the output end of the drive motor connected through transmission to one of the adjusting screws via the bevel gear set.

Compared with the prior art, the beneficial effects of the invention are as follows: as for the invention with a pipe fixing assembly installed at the inner wall of the underground space on both the left and right sides and the pipe fixing assembly including a number of lifting frames set vertically from top to bottom and a lifting mechanism, when the pipe, pipe holder and lifting frame are vibrated, the lifting frame slides on the inner wall of the underground space, the relative movement occurs between two adjacent pipe holders, and the vibration is absorbed by the telescopic spring, so that hard contact between pipe and vibration is avoided, and vibration is reduced to protect the pipe, improving the aseismic capacity of the underground pipe rack.

### BRIEF DESCRIPTION OF THE DRAWINGS

FIG. 1 is a structural schematic diagram for the system for enhancing the damping capacity and aseismic capacity of the underground integrated pipe rack.

FIG. 2 is a partial schematic diagram for Part A in FIG. 1.

FIG. 3 is a partial schematic diagram for Part B in FIG. 1.

FIG. 4 is a structural schematic diagram for the pipe holder in the system for enhancing the damping capacity and aseismic capacity of the underground integrated pipe rack.

FIG. 5 is a top view for connection of pipe to the pipe holder in the system for enhancing the damping capacity and aseismic capacity of the underground integrated pipe rack.

FIG. 6 is a top view for the pipe holder in the system for enhancing the damping capacity and aseismic capacity of the underground integrated pipe rack.

FIG. 7 is a structural schematic diagram for the lifting mechanism in the system for enhancing the damping capacity and aseismic capacity of the underground integrated pipe rack.

In the figures, 1—underground space, 2—lifting frame, 201—through slot, 202—sliding chute, 203—lifting slide block, 204—buffer spring, 3—pipe holder, 301—upper clamp, 302—lower clamp, 303—arc sliding chute, 304—fastening bolt, 305—connecting rod, 306—telescopic spring, 4—lifting mechanism, 401—base, 402—drive motor, 403—sleeve, 404—lifting column, 405—screw sleeve, 406—adjusting screw, 407—synchronous belt, 408—bevel gear set, 5—mounting stem, 6—universal joint, 7—spherical slide block.

### DETAILED DESCRIPTION OF THE EMBODIMENTS

The technical scheme of this patent is described in detail below in combination with specific embodiments.

Embodiments of the patent are described in detail below, and examples of the said embodiments are shown in the attached figures, wherein identical or similar labels throughout indicate identical or similar components or components having the same or similar functions. The embodiments described below by reference to the attached figures are exemplary and are intended only to interpret the patent and are not to be construed as a limitation of this patent.

In the description of this patent, it should be understood that the terms “center”, “up”, “down”, “front”, “back”, “left”, “right”, “vertical”, “horizontal”, “top”, “bottom”, “inside”, “outside”, etc. indicate an orientation or positional relationship based on those shown in the attached figures and are used only to facilitate and simplify the description of this patent, not to indicate or imply that the device or component referred to must have a particular orientation, be constructed or operated in a particular orientation, and therefore cannot be construed as a limitation of this patent.

In the description of this patent, it should be noted that unless otherwise expressly specified and limited, the terms “mounting”, “connecting” and “setting” should be understood in a broad sense, for example, it can be fixed connection or setting, or detachable connection or setting, or integral connection or setting. To a person with ordinary skill in the field, the specific meaning of the above terms in the patent can be understood on a case-by-case basis.

### Embodiment 1

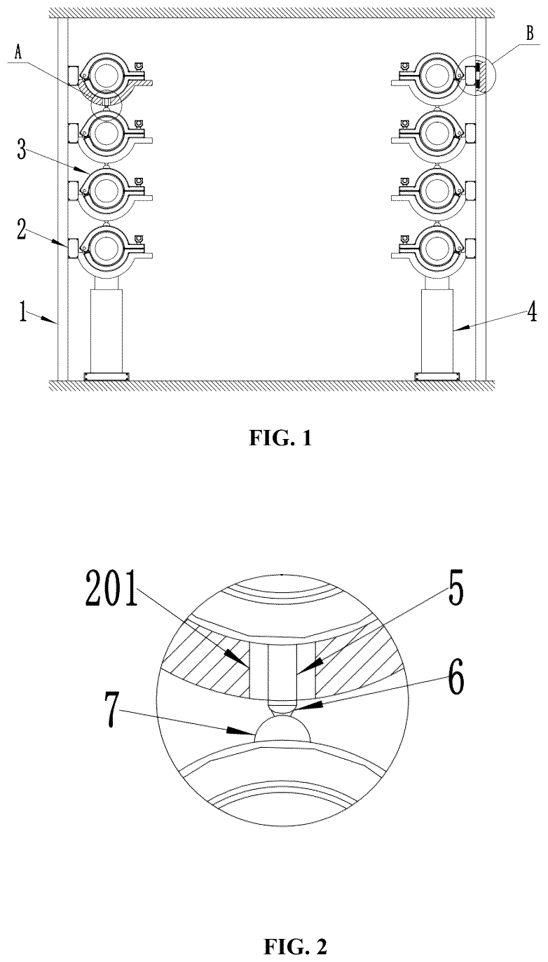

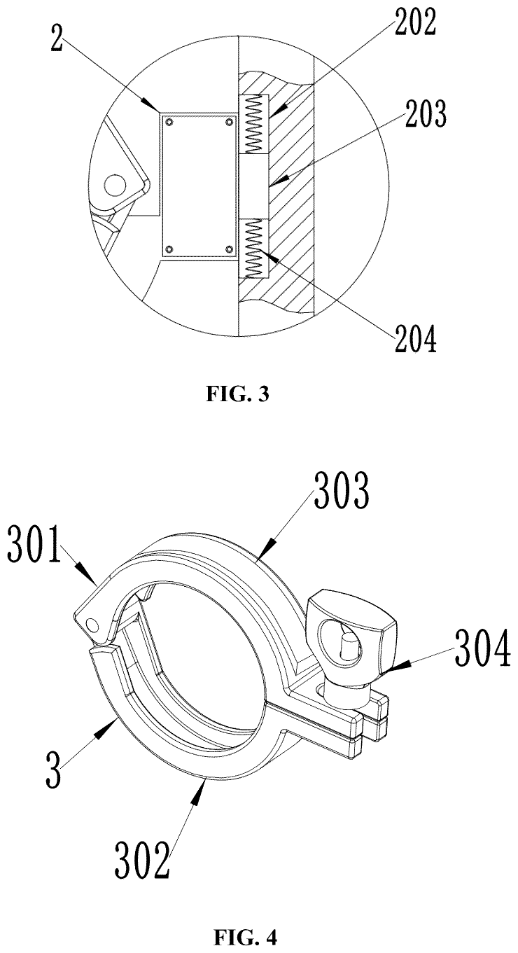

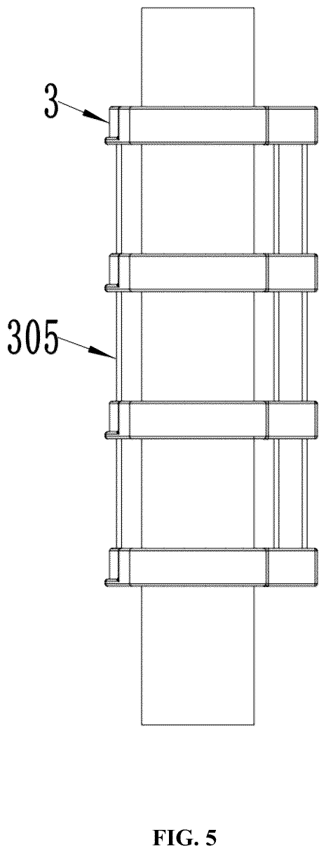

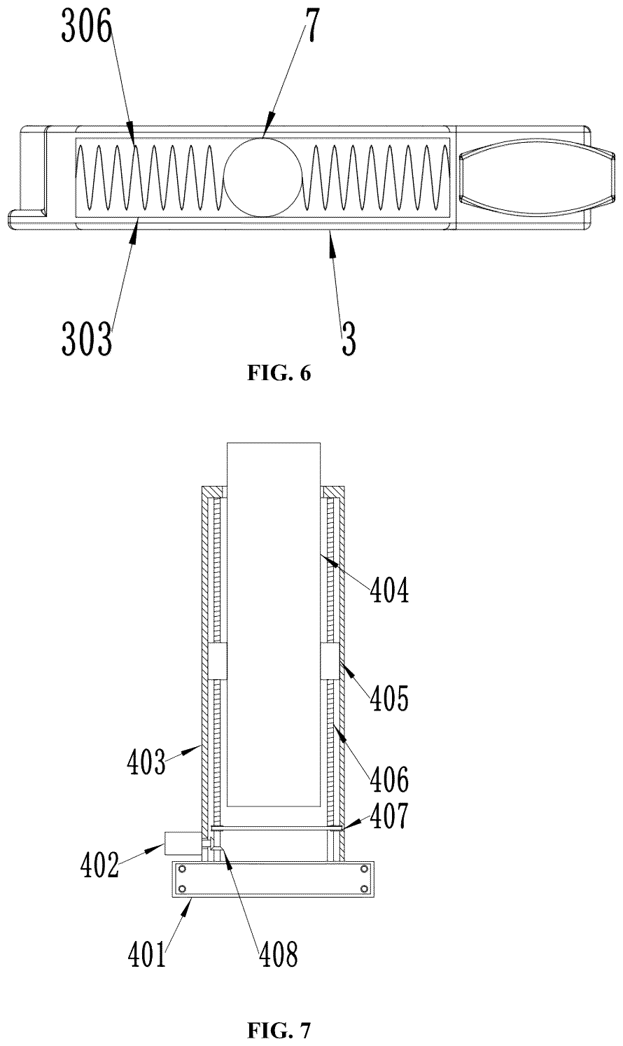

As shown in FIGS. 1-6, in the embodiment of the patent, the invention relates to a system for enhancing the damping capacity and aseismic capacity of the underground integrated pipe rack, which includes a pipe fixing assembly installed at the inner wall of the underground space 1 on both the left and right sides. The said pipe fixing assembly includes a number of lifting frames 2 set vertically from top to bottom and a lifting mechanism 4. The telescopic end of the said lifting mechanism 4 is fixedly connected to the lowermost lifting frame 2. One side of the said lifting frame 2 is slidingly connected to the inner wall of the underground space 1. The lifting frame 2 is provided with a recess for placing the pipe, and a pipe holder 3 for fixing the pipe is installed inside the recess. A spherical slide block 7 is movably mounted on the lower part of the pipe holder 3. The upper part of the pipe holder 3 is also provided with an arc sliding chute 303 for spherical slide block 7 sliding. The spherical slide block 7 is slidingly mounted in the arc sliding chute 303 on the pipe holder 3 on the adjacent side, and the spherical slide block 7 is fixedly connected with the arc sliding chute 303 through a telescopic spring 306. When the pipe, pipe holder 3 and lifting frame 2 are vibrated, the lifting frame 2 slides on the inner wall of the underground space 1, the relative movement occurs between two adjacent pipe holders 3, and the vibration is absorbed by the telescopic spring 306, so that hard contact between pipe and vibration is avoided, and vibration is reduced to protect the pipe.

In the embodiment of the patent, several sliding chutes 202 are arranged on the inner wall on both the left and right sides in the said underground space 1, with the sliding chutes 202 corresponding to the lifting frames 2 one by one. The lifting frames 2 are slidingly mounted on the sliding chutes 202 through lifting slide blocks 203 whose upper and lower ends are fixedly connected with the sliding chutes 202 through the buffer spring 204. The lifting frames 2, when subjected to vibration, slide up and down to avoid damage to the lifting frames 2;

In the embodiment of the patent, a mounting stem 5 is vertically installed on the bottom of the said pipe holder 3, and the said spherical slide block 7 is movably installed on the lower end of the mounting stem 5 through universal joint 6. A through slot 201 for mounting stem 5 installation is provided on the bottom of the said pipe holder 3.

In the embodiment of the patent, the said pipe holder 3 includes upper clamp 301 and lower clamp 302, both of which are of semi-circular structure, with one end of upper clamp 301 and lower clamp 302 hinged to each other, and the other end of upper clamp 301 and lower clamp 302 detachably connected by fixing bolts for clamping and fixing the pipe.

In the embodiment of the patent, there are several pipe holders 3 uniformly arranged along the pipe length direction, with the two adjacent pipe holders 3 fixedly connected through several connecting rods 305, so as to fix the pipe as a whole.

### Embodiment 2

As shown in FIGS. 1-6, in the embodiment of the patent, the invention relates to a system for enhancing the damping capacity and aseismic capacity of the underground integrated pipe rack, which includes a pipe fixing assembly installed at the inner wall of the underground space 1 on both the left and right sides. The said pipe fixing assembly includes a number of lifting frames 2 set vertically from top to bottom and a lifting mechanism 4. The telescopic end of the said lifting mechanism 4 is fixedly connected to the lowermost lifting frame 2. One side of the said lifting frame 2 is slidingly connected to the inner wall of the underground space 1. The lifting frame 2 is provided with a recess for placing the pipe, and a pipe holder 3 for fixing the pipe is installed inside the recess. A spherical slide block 7 is movably mounted on the lower part of the pipe holder 3. The upper part of the pipe holder 3 is also provided with an arc sliding chute 303 for spherical slide block 7 sliding. The spherical slide block 7 is slidingly mounted in the arc sliding chute 303 on the pipe holder 3 on the adjacent side, and the spherical slide block 7 is fixedly connected with the arc sliding chute 303 through a telescopic spring 306. When the pipe, pipe holder 3 and lifting frame 2 are vibrated, the lifting frame 2 slides on the inner wall of the underground space 1, the relative movement occurs between two adjacent pipe holders 3, and the vibration is absorbed by the telescopic spring 306, so that hard contact between pipe and vibration is avoided, and vibration is reduced to protect the pipe.

In the embodiment of the patent, several sliding chutes 202 are arranged on the inner wall on both the left and right sides in the said underground space 1, with the sliding chutes 202 corresponding to the lifting frames 2 one by one. The lifting frames 2 are slidingly mounted on the sliding chutes 202 through lifting slide blocks 203 whose upper and lower ends are fixedly connected with the sliding chutes 202 through the buffer spring 204. The lifting frames 2, when subjected to vibration, slide up and down to avoid damage to the lifting frames 2;

In the embodiment of the patent, a mounting stem 5 is vertically installed on the bottom of the said pipe holder 3, and the said spherical slide block 7 is movably installed on the lower end of the mounting stem 5 through universal joint 6. A through slot 201 for mounting stem 5 installation is provided on the bottom of the said pipe holder 3.

In the embodiment of the patent, the said pipe holder 3 includes upper clamp 301 and lower clamp 302, both of which are of semi-circular structure, with one end of upper clamp 301 and lower clamp 302 hinged to each other, and the other end of upper clamp 301 and lower clamp 302 detachably connected by fixing bolts for clamping and fixing the pipe.

In the embodiment of the patent, there are several pipe holders 3 uniformly arranged along the pipe length direction, with the two adjacent pipe holders 3 fixedly connected through several connecting rods 305, so as to fix the pipe as a whole.

As shown in FIG. 7, this embodiment differs from Embodiment 1 in that:

The said lifting mechanism 4 includes a base 401, a sleeve 403 and a lifting column 404; the said sleeve 403 is fixedly installed in the said base 401, and the upper end of the sleeve 403 is opened, in which the said lifting column 404 is set; inside the said sleeve 403, there are two adjusting screws 406 symmetrically connected in a threaded way on the left and right sides of the said lifting column 404, and screw sleeves 405 are connected in a threaded way on the adjusting screws 406, with one side of the screw sleeve 405 slidingly connected to the inner wall of the sleeve 403 and the other side fixedly connected to the lifting column 404, so as to drive the lifting column 404 up and down;

Further, in the embodiment of the invention, synchronous pulleys are fixedly mounted on the lower end of the said adjusting screw 406, with two adjacent synchronous pulleys connected by a synchronous belt 407 through transmission, so as to keep the two adjusting screws 406 rotating synchronously; a drive motor 402 is fixedly mounted on the said sleeve 403, with the output end of the drive motor 402 connected through transmission to one of the adjusting screws 406 via the bevel gear set 408, for driving the adjusting screw 406 to rotate.

The above are only preferred embodiments of the invention, and it should be noted that for a person skilled in the art, a number of transformations and improvements can be made without deviating from the conception of the invention, which should also be considered as falling within the scope of protection of the invention and should not affect the effect of the implementation of the invention and the practicality of the patent.

What is claimed is:

1. The invention relates to a system for enhancing the damping capacity and aseismic capacity of the underground integrated pipe rack, which is characterized in that the system includes a pipe fixing assembly installed at the inner wall of the underground space (1) on both the left and right sides. The said pipe fixing assembly includes a number of lifting frames (2) set vertically from top to bottom and a lifting mechanism (4). The telescopic end of the said lifting mechanism (4) is fixedly connected to the lowermost lifting frame (2). One side of the said lifting frame (2) is slidingly connected to the inner wall of the underground space (1). The lifting frame (2) is provided with a recess for placing the pipe, and a pipe holder (3) for fixing the pipe is installed inside the recess. A spherical slide block (7) is movably mounted on the lower part of the pipe holder (3). The upper part of the pipe holder (3) is also provided with an arc sliding chute (303) for spherical slide block (7) sliding. The spherical slide block (7) is slidingly mounted in the arc sliding chute (303) on the pipe holder (3) on the adjacent side, and the spherical slide block (7) is fixedly connected with the arc sliding chute (303) through a telescopic spring (306).

2. The system for enhancing the damping capacity and aseismic capacity of the underground integrated pipe rack, as described in claim 1, is characterized in that several sliding chutes (202) are arranged on the inner wall on both the left and right sides in the said underground space (1), with the sliding chutes (202) corresponding to the lifting frames (2) one by one. The lifting frames (2) are slidingly mounted on the sliding chutes (202) through lifting slide blocks (203) whose upper and lower ends are fixedly connected with the sliding chutes (202) through the buffer spring (204).

3. The system for enhancing the damping capacity and aseismic capacity of the underground integrated pipe rack, as described in claim 1, is characterized in that a mounting stem (5) is vertically installed on the bottom of the said pipe holder (3), and the said spherical slide block (7) is movably installed on the lower end of the mounting stem (5) through universal joint (6). A through slot (201) for mounting stem (5) installation is provided on the bottom of the pipe holder (3).

4. The system for enhancing the damping capacity and aseismic capacity of the underground integrated pipe rack, as described in claim 1, is characterized in that the said pipe holder (3) includes upper clamp (301) and lower clamp (302), both of which are of semi-circular structure, with one end of upper clamp (301) and lower clamp (302) hinged to each other, and the other end of upper clamp (301) and lower clamp (302) detachably connected by fixing bolts (304).

5. The system for enhancing the damping capacity and aseismic capacity of the underground integrated pipe rack, as described in claim 4, is characterized in that there are several pipe holders (3) uniformly arranged along the pipe length direction, with the two adjacent pipe holders (3) fixedly connected through several connecting rods (305).

6. The system for enhancing the damping capacity and aseismic capacity of the underground integrated pipe rack, as described in claim 1, is characterized in that the said lifting mechanism (4) includes a base (401), a sleeve (403) and a lifting column (404); the said sleeve (403) is fixedly installed in the said base (401), and the upper end of the sleeve (403) is opened, in which the said lifting column (404) is set; inside the said sleeve (403), there are two adjusting screws (406) symmetrically connected in a threaded way on the left and right sides of the said lifting column (404), and screw sleeves (405) are connected in a threaded way on the adjusting screws (406), with one side of the screw sleeve (405) slidingly connected to the inner wall of the sleeve (403) and the other side fixedly connected to the lifting column (404).

7. The system for enhancing the damping capacity and aseismic capacity of the underground integrated pipe rack, as described in claim 6, is characterized in that synchronous pulleys are fixedly mounted on the lower end of the said adjusting screw (406), with two adjacent synchronous pulleys connected by a synchronous belt (407) through transmission.

8. The system for enhancing the damping capacity and aseismic capacity of the underground integrated pipe rack, as described in claim 7, is characterized in that a drive motor (402) is fixedly mounted on the said sleeve (403), with the output end of the drive motor (402) connected through transmission to one of the adjusting screws (406) via the bevel gear set (408).
